(19) United States
(12) Patent Application Publication
(10) Pub. No.: US 2023/0159808 A1
(43) Pub. Date: May 25, 2023

(54) HEAT TRANSFER COMPOSITIONS OF HYDROFLUOROCARBONS

(71) Applicant: Arkema Inc., King of Prussia, PA (US)

(72) Inventors: Benjamin Bin CHEN, King of Prussia, PA (US); Sarah KIM, King of Prussia, PA (US); Brian Thomas KOO, King of Prussia, PA (US); Lucy Mary CLARKSON, King of Prussia, PA (US)

(21) Appl. No.: 17/922,997

(22) PCT Filed: May 4, 2021
(86) PCT No.: PCT/US2021/030608

§ 371 Date: Nov. 3, 2022

Related U.S. Application Data
(60) Provisional application No. 63/021,697, filed on May 8, 2020.

(51) Int. Cl. C09K 5/04; C10M 171/00; C09K 3/30; C08J 9/14

(52) U.S. Cl. CPC C09K 5/044; C09K 5/045; C10M 171/008; C09K 3/30; C08J 9/144; C09K 2205/122; C09K 2205/126; C08J 2203/142; C08J 2203/162; C08J 2300/00; C09K 2205/24; C09K 2205/43

(57) ABSTRACT

The present invention relates to heat transfer compositions comprising 1-chloro-1,2 difluoroethylene for use in refrigeration, air conditioning, heat pump systems, chillers, and other heat transfer applications. The inventive heat transfer compositions can possess reduced global warming potential while providing good capacity and performance while providing preferable flammability characteristics

### FIELD OF THE INVENTION

The present invention relates to heat transfer compositions comprising 1-chloro-1,2 difluoroethylene (HFO-1122a) for use in refrigeration, air-conditioning, heat pump systems, chillers, automotive air conditioning, organic rankine cycle systems and other heat transfer applications. The inventive heat transfer compositions can possess reduced global warming potential while providing good capacity and performance.

### BACKGROUND OF INVENTION

With continued regulatory pressure there is a growing need to identify more environmentally sustainable replacements for refrigerants, heat transfer fluids, foam blowing agents, solvents, and aerosols with lower ozone depleting and global warming potentials. Chlorofluorocarbon (CFC) and hydrochlorofluorocarbons (HCFC), widely used for these applications, are ozone depleting substances and are being phased out in accordance with guidelines of the Montreal Protocol. Hydrofluorocarbons (HFC) are a leading replacement for CFCs and HCFCs in many applications. Though they are deemed “friendly” to the ozone layer they still generally possess high global warming potentials.

For instance several HFC-based refrigerants have been developed to replace. R-22, an HCFC refrigerant with ozone depletion potential (ODP). These include R-404A, R-407C, R-407A, R-417A, R-422D, R-427A, R-438A, and others. However, most of the HFC-based R-22 replacements have higher global warming potential (GWP) than R-22 while also compromising in performance characteristics. For example, R-404A and R-407A may have slightly higher refrigeration capacity (CAP) than R-22 under some conditions but have lower performance (COP); R-407C has slightly lower GWP but also lower CAP and COP in refrigeration applications; many other R-22 replacements have not only a higher GWP but lower CAP and COP. FIG. 3 shows a comparison of the GWP of R-22 and several R-22 replacements.

Safety concerns currently limit the widespread adoption of flammable refrigerants for commercial and residential use. The selection of refrigerants for vapor compression HVAC&R systems requires tradeoffs between performance, safety, and environmental impact. The current generation of refrigerants such as R-404A are typically composed of blends of flammable and non-flammable fluids in which the overall composition is classified as non-flammable. These refrigerants are intended to be: replacements for historically used single molecule fluids like R-11 and R-22. However, R-410A and R-404A have a high to very high global warming potential (GWP), and it has been difficult to find a refrigerant that is efficient, non-toxic, and non-flammable while also possessing a low GWP.

Most environmentally acceptable refrigerants are flammable and most research to date has focused on adapting the design of refrigeration and air-conditioning systems to best handle flammable refrigerant fluids. These studies identified ways to mitigate the flammability by limiting the charge of refrigerants and/or designing the system with additional ventilation. Most recent studies have focused on intrinsic ways to limit the flammability of the refrigerants without changing baseline refrigerant performance and GWP impact. Indeed, the traditional way to suppress the flammability of a refrigerant is to blend it with a known non-flammable refrigerant that has acceptable thermodynamic properties to generate a non-flammable blend. A current example is R-410A, a non-flammable blend of R-32 with a 21L classification and R-125 with a 1 classification. However, because R-125 has a high GWP, it can only be added in a small amount, which limits its potential to reduce flammability in blends with other flammable refrigerants.

The refrigerating capacity represents the refrigeration power available by virtue of the refrigerant, for a given compressor. In order to replace R-22, it is essential to have available a fluid having a high refrigerating capacity close to that of R-22.

The COP expresses the ratio of the refrigerating energy delivered to the energy applied to the compressor in order to compress the refrigerant in the vapor state. In the context of the substitution of R-22, a COP value of the refrigerant which is less than. that of R-22 is suitable, if an increase in the consumption of electricity of the plant is accepted.

Finally, the condensation pressure indicates the stress exerted by the refrigerant on the corresponding mechanical parts of the refrigerating circuit. A refrigerant capable of replacing an existing refrigeration system designed for the latter must not exhibit a condensation pressure significantly greater than that of existing refrigerant.

In the present invention, heat transfer compositions were discovered that not only have a low GWP but have an unexpectedly low flammability and a good balance between capacity and performance. Though not meant to limit the scope of this invention in any way, the heat transfer compositions of the present invention are useful in new refrigeration, air conditioning, heat pump, chiller, or other heat transfer equipment; in another embodiment, the heat transfer compositions of the present invention are useful as retrofits for refrigerants in existing equipment including, but not limited to, R-22, R-407C, R-427A, R-404A, R-507, R-407A, R-407F, R-417A, R-422D, and others.

### DETAILED DESCRIPTION OF INVENTION

With continued regulatory pressure there is a growing need to identify more environmentally sustainable replacements for refrigerants, heat transfer fluids, foam blowing agents, solvents, and aerosols with lower ozone depleting and global warming potentials. Chlorofluorocarbon (CFC) and hydrochlorofluorocarbons (HCFC), widely used for these applications, are ozone depleting substances and are being phased out in accordance with guidelines of the Montreal Protocol. Hydrofluorocarbons (HFC) are a leading replacement for CFCs and HCFCs in many applications; though they are deemed “friendly” to the ozone layer they still generally possess high global warming potentials. One new class of compounds that has been identified to replace ozone depleting or high global warming substances are halogenated olefins, such as hydrofluoroolefins (HFO) and hydrochlorofluoroolefins (HCFO).

The heat transfer compositions of the present invention are comprised of 1-chloro-1,2 difluoroethylene (HCFO-1122a) alone or in combination with other refrigerants including, but not limited to, hydrofluorocarbons, hydrochlorofluorocarbons, hydrofluoroolefins, hydrofluorochloroolefins, hydrocarbons, hydrofluoroethers, fluoroketones, chlorofluorocarbons, trans-1,2-dichloroethylene, carbon dioxide, ammonia, dimethyl ether, propylene, and mixtures thereof. HCFO-1122a exists in both cis- and trans isomeric forms. As used herein, HCFO-1122a refers to all 1-chloro-1,2 difluoroethylenes whether independently cis-HCFO-1122a or trans-HCFO-1122a or some combination or mixture of cis-HCFO-1122a and trans-HCFO-1122as.

The term “HFO-1225” is used herein to refer to all pentafluoropropenes. Among such molecules are included 1,1,1,2,3 pentafluoropropene (HFO-1225yez), both cis- and trans-forms thereof. The term HFO-1225yez is thus used herein generically to refer to 1,1,1,2,3 pentafluoropropene, independent of whether it is the cis- or trans-form. The term “HFO-1225yez” therefore includes within its scope cis-HFO-1225yez, trans-HFO-1225yez, and all combinations and mixtures of these.

The flammability profile of HCFO-1122a provides heat transfer compositions that not only have a low GWP but may have an unexpectedly low flammability and a good balance between capacity and performance.

Exemplary hydrofluorocarbons (HFCs) that can be used in combination with 1-chloro-1,2 difluoroethylene (HFO-1122a) include difluoromethane (HFC-32); 1-fluoroethane (HFC-161); 1,1-difluoroethane (HFC-152a); 1,2-difluoroethane (HFC-152); 1,1,1-trifluoroethane (HFC-143a); 1,1,2-trifluoroethane (HFC-143); 1,1,1,2-tetrafluoroethane (HFC-134a); 1,1,2,2-tetrafluoroethane (HFC-134); 1,1,1,2,2-pentafluoroethane (HFC-125); 1,1,1,3,3-pentafluoropropane (HFC-245fa); 1,1,2,2,3-pentafluoropropane (HFC-245ca); 1,1,1,2,3-pentafluoropropane (HFC-245eb); 1,1,1,3,3,3-hexafluoropropane (HFC-236fa); 1,1,1,2,3,3,3-heptafluoropropane (HFC-227ea); 1,1,1,3,3-pentafluorobutane (HFC-365mfc), 1,1,1,2,3,4,4,5,5,5-decafluoropropane (HFC-4310), 1,1,1,2,3,3,3-heptafluoropropane (HFC-227ea)and mixtures thereof. Preferred hydrofluorocarbons include HFC-134a, HFC-32, HFC-152a, HFC-125, and mixtures thereof.

Exemplary hydrofluoroolefins (HFOs) include trifluoroethylene (HFO-1123), 1,1-difluoroethylene (R-1132a), 1,2-difluoroethylene (HFO-1132 particularly the E-isomer), 3,3,3-trifluoropropene (HFO-1234zf), 1,3,3,3-tetrafluoropropene (HFO-1234ze), particularly the E-isomer, 2,3,3,3-tetrafluoropropene (HFO-1234yf), 1,2,3,3,3-pentafluoropropene (HFO-1255ye), particularly the Z-isomer, E-1,1,1,3,3,3-hexafluorobut-2-ene (R-1336mzz(E)), Z-1,1,1,3,3,3-hexafluorobut-2-ene (R-1336mzz(Z)), 1,1,1,4,4,5,5,5-octafluoropent-2-ene (HFO-1438mzz) and mixtures thereof. Preferred hydrofluoroolefins include 1,1-difluoroethylene (R-1132a), E-1,2-difluoroethylene (HFO-1132(E)), 3,3,3-trifluorpropene (HFO-1234zf), E-1,3,3,3-tetrafluoropropene (HFO-1234ze(E)), 2,3,3,3-tetrafluoropropene (HFO-1234yf), E-1,1,1,3,3,3-hexafluorobut-2-ene (R-1336mzz(E)) and mixtures thereof.

Exemplary hydrochlorofluoroolefins (HCFOs) include 1-chloro-3,3,3-trifluoropropene (HCFO-1233zd, particularly the E-isomer), 1-chloro-2,3,3,3-tetrafluoropropene (HCFO-1224yd, particularly the Z-isomer), 2-chloro-3,3,3-trifluoropropene (HCFO-1233xf), and dichloro-tetrafluoropropenes; such as isomers of HCFO-1214.

Exemplary iodocarbons include trifluoroiodomethane (R-1311).

Exemplary hydrocarbons (HCs) include propylene, propane, butane, isobutane, n-pentane, iso-pentane, neo-pentane, cyclopentane, and mixtures thereof. Preferred hydrocarbons include propylene, propane, butane, and iso-butane.

Exemplary hydrochlorofluorocarbons (HCFCs) include chloro-difluoromethane (HCFC-22), 1-chloro-1,1-difluoroethane (HCFC-142b), 1,1-dichloro-1-fluoroethane (HCFC-141b), 1,1-dichloro-2,2,2-trifluoroethane (HCFC-123), and 1-chloro-1,2,2,2-tetrafluoroethane (HCFC-124).

Exemplary chlorofluorocarbons (CFCs) include trichlorofluoromethane (R-11), dichlorodifluoromethane (R-12), 1,1,2-trifluoro-1,2,2-trifluoroethane (R-113), 1,2-dichloro-1,1,2,2-tetrafluoroethane (R-114), chloro-pentafluoroethane (R-115) and mixtures thereof.

Exemplary hydrofluoroethers (HFEs) include 1,1,1,2,2,3,3-heptafluoro-3-methoxy-propane, 1,1,1,2,2,3,3,4,4-nonafluoro-4-methoxy-butane and mixtures thereof.

An exemplary fluoroketone is 1,1,1,2,2,4,5,5,5-nonafluoro-4(trifluoromethyl)-3-pentanone.

Flammability is an important property for many applications where it is very important or essential for the composition to be non-flammable or mildly flammable, including particularly refrigerant and heat transfer applications. There are various methods of measuring the flammability of compounds and compositions, such as by measuring flash point or by ASTM E681 as specified by ANSI/ASHRAE 34-2019 Appendix B, as applicable. Preferably, the non-flammable compositions are non-flammable at ambient temperature and lower, preferably are non-flammable at 60° C. and lower, and even more preferably are non-flammable at 100° C. and lower. Mildly flammable refrigerants exhibit a burning velocity below a certain value at 23° C. as specified in ANSI/ASHRAE 34-2019 Section 6. A greater range for non-flammability is beneficial by providing a greater degree of safety during use, handling, or transport.

In a preferred embodiment of the present invention, the heat transfer compositions of the present invention exhibit a reduced flammability profile including lower flammability and no flame propagation as defined in ANSI/ASHRAE 34-2019. Preferably, the heat transfer composition of the present invention exhibits reduced flammability and maintains reduced flammability upon fractionation between a liquid and vapor phase. For example, in a 50% leak test a vessel is charged with an initial composition, which preferably exhibits reduced flammability. The vessel can be maintained at a desired temperature, such as −25° C. or 25° C., and the initial vapor phase composition is measured, and preferably exhibits reduced flammability. The composition is allowed to leak from the vessel at constant temperature and set leak rate until 50% by weight of the initial composition is removed, at which time the final vapor phase composition is measured, and preferably exhibits reduced flammability.

In a preferred embodiment of the present invention, the heat transfer compositions exhibit minimal change in composition or vapor pressure following a leak of the heat transfer composition from a vessel or equipment. In one such leak case, the heat transfer composition of the present invention is charged to a vessel and maintained at constant temperature. The heat transfer composition is permitted to leak from the vessel at a slow rate until 50% by weight of the overall composition has escaped the vessel. In a preferred embodiment of the present invention, the vapor pressure of the heat transfer composition will not have significantly changed following the 50% leak; preferably the vapor pressure has changed less than 20%, more preferably less than 10%, more preferably less than 5%, and even more preferably less than 2%. In another embodiment of the present invention, the vapor and liquid phases in the vessel following the 50% leak exhibits reduced flammability.

Though not meant to limit the scope of the present invention in any way, examples of heat transfer compositions of the present invention for use as replacements for R-22, R-407C, R-404A, R-410A, R-134a, and/or R-507 are shown in Table 1. It is understood that slight variations in the compositions should be considered as being within the scope of the present invention; including, but not limited to, compositions within +/−3 wt %, preferably within +/−2 wt %, more preferably within +/−1 wt %. Currently a GWP for HFO-1122a has not been established. For purposes of the following examples, the GWP of HFO-1122a has been estimated to 5 or less.

Though not meant to limit the scope of the present invention in any way, examples of heat transfer compositions of the present invention further comprising R-134a, R-1234yf, and mixtures for use as replacements for R-22, R-407C, R-404A, R-410A, R-134a, and/or R-507 are shown in Table 2. It is understood that slight variations in the compositions should be considered as being within the scope of the present invention; including, but not limited to, compositions +/−3 wt %, preferably within +/−2 wt %, more preferably within +/−1 wt %.

Glide, also known as temperature glide, is the absolute value of the difference between the starting and ending temperatures of a phase-change process by a refrigerant within a component of a refrigerating system, exclusive of any subcooling or superheating. This term usually describes condensation or evaporation of a zeotrope. An embodiment of the present invention are heat transfer compositions that have a low glide; preferably where the glide is less 12° C., more preferably where the glide is less 7° C., even more preferably where the glide is less than 5° C., even more preferably where the glide is less than 2° C., and even more preferably where the glide is less than 1° C.

The global warming potential (GWP) is a relative measure of how much heat a gas traps in the atmosphere. GWP is typically expressed relative to carbon dioxide over a 100 year time period. An embodiment of the present invention are heat transfer compositions with a low GWP value, preferably where the GWP is less than 1000, more preferably less than 800, more preferably <600, more preferably <400 and even more preferably <200. In another embodiment of the present invention are heat transfer compositions where the GWP is between about 1 and 1000.

An embodiment of the present invention are heat transfer compositions that when used in refrigeration, air-conditioning, chiller, or heat pump systems provide similar or better capacity, performance, or both than HFC or HCFC based refrigerants used in similar applications.

An embodiment of the present invention are heat transfer compositions that are used to replace R-22 or R-407C; the heat transfer compositions may be used to retrofit existing equipment installed with or comprising R-22 or R-407C; the heat transfer compositions may also be used in new equipment designed for R-22 or R-407C.

An embodiment of the present invention are heat transfer compositions that are used to replace R-404A or R-507; the heat transfer compositions may be used to retrofit existing equipment installed with or comprising R-404A or R-507; the heat transfer compositions may also be used in new equipment designed for R-404A or R-507.

An embodiment of the present invention are heat transfer compositions that are used to replace R-134a.

An embodiment of the present invention are heat transfer compositions that are used to replace R-407A or R-407F.

An embodiment of the present invention are heat transfer compositions that are used to replace R-410A.

In order for a new refrigerant to be used to retrofit an existing system or used a new system designed for another refrigerant, it is important that the operating properties of the new refrigerant be as close as possible to those that the equipment was designed or installed for; a benefit of this is to minimize the changes to the equipment or operating conditions when changing refrigerants, which can be difficult, time consuming, and costly. Such properties include the refrigerant mass flow rate, the refrigerant capacity, the coefficient of performance (COP), efficiency, the pressure ratio, and the discharge temperature at the desired operating conditions. For example, if the mass flow rate is significantly different when using the new refrigerant it may require changing thermostatic expansion valves (TXV) in the system. Example operating conditions, not meant to limit the scope of the present invention in any way, are low temperature refrigeration, medium temperature refrigeration, air-conditioning, heating, high-ambient refrigeration or air-conditioning, etc.

In an embodiment of the present invention, the mass flow rate of the heat transfer composition of the present invention is within 20%, preferably within 15%, more preferably within 10%, even more preferably within 5%, and even more preferably within 2% of the mass flow rate of R-22 or R-404A or R-407C when used in a refrigeration, air-conditioning, chilling, or heat pump system. In an embodiment of the present invention, the capacity of the heat transfer composition of the present invention is not less than 80%, preferably not less than 85%, more preferably not less than 90%, even more preferably not less than 95%, and even more preferably not less than 98% of the capacity of R-22 or R-404A or R-407C when used in a refrigeration, air-conditioning, chilling, or heat pump system. In an embodiment of the present invention, the efficiency of the system using the heat transfer composition of the present invention is not less than 80%, preferably not less than 85%, more preferably not less than 90%, even more preferably not less than 95%, and even more preferably not less than 98% of the efficiency of the system using R-22 or R-404A or R-407C when used in a refrigeration, air-conditioning, chilling, or heat pump system. In an embodiment of the present invention, the COP of the heat transfer composition of the present invention is not less than 80%, preferably not less than 85%, more preferably not less than 90%, even more preferably not less than 95%, and even more preferably not less than 98% of the COP of R-22 or R-404A or R-407C when used in a refrigeration, air-conditioning, chilling, or heat pump system. In an embodiment of the present invention, the compressor discharge temperature of the heat transfer composition of the present invention is not more than 60° F. higher, preferably not less more than 50° F. higher, more preferably not more than 40° F. higher, even more preferably more than 30° F. higher than the compressor discharge temperature of R-22 or R-404A or R-407C when used in a refrigeration, air-conditioning, chilling, or heat pump system; in another preferred embodiment of the present invention, the system uses liquid injection.

In an aspect of the present invention is, a method of producing low temperature refrigeration using a heat transfer composition of the present invention, particularly in a system designed for R-22, R-407C, R-404A, R-134a, R-410A and/or R-507, particularly R-22 and/or R-404A.

In an aspect of the present invention is a method of producing medium temperature refrigeration using a heat transfer composition of the present invention, particularly in a system designed for R-22, R-407C, R-404A, R-134a, R-410A and/or R-507, particularly R-22 and/or R-404A.

In an aspect of the present invention is a method of producing air-conditioning using a heat transfer composition of the present invention, particularly in a system designed for R-22, R-407C, R-404A, R-134a, R-410A and/or R-507, particularly R-22 and/or R-407C.

In an aspect of the present invention is a method of retrofitting a heat transfer system with a heat transfer composition of the present invention.

The heat transfer compositions of the present invention may be used in combination with a lubricating oil. Exemplary lubricating oils include polyol esters, polyalkylene glycols, polyglycols, polyvinyl ethers, mineral oils, alkyl benzene oil, polyalpha olefins, and mixtures thereof. Lubricating oils of the present invention range from very low to high viscosity, preferably with viscosities at 100° F. from 15 to 800 cSt, and more preferably, from 20 to 100 cSt. The typical refrigeration lubricating oils used in the present invention had viscosities of 15, 32, 68, and 100 cSt at 100° F.

The following is a exemplary description of polyol ester (POE) lubricating oils and is not meant to limit the scope of the present invention in any way POE oils are typically formed by a chemical reaction (esterification) of a carboxylic acid, or mixture of carboxylic acids, with an alcohol, or mixtures of alcohols. The carboxylic acids are typically mono-functional or di-functional. The alcohols are typically mono-functional or poly-functional (polyols). The polyols are typically di-, tri-, or tetra-functional. Examples of polyols include, but are not limited to, neopentylglycol, glycerin, trimethylolpropane, pentaerythritol, and mixtures thereof. Examples of carboxylics acids include, but are not limited to, ethyl hexanoic acid, including 2-ethyl hexanoic acid, trimethyl hexanoic acid, including 3,5,5-trimethyl hexanoic acid, octanoic acid, including linear octanoic acid, pentanoic acid, including n-pentanoic acid, neo acids, including dimethylpentanoic acid, C5 to C20 carboxylic acids, and mixtures thereof. The carboxylic acids may also be derived from natural sources, including, but not limited to, plant and vegetable oils of soybean, palm, olive, rapeseed, cottonseed, coconut, palm kernal, corn, castor, sesame, jojoba, peanut, sunflower, others, and mixtures thereof. Natural oil carboxylic acids are typically C18 acids but also include C12-C20 acids, among others. In one embodiment of the present invention, the POE oil is formulated using one or more mono-functional carboxylic acid with one or more polyol. In one embodiment of the present invention, the POE oil is formulated using one or more di-functional carboxylic acid with one or more mono-functional alcohol. In one embodiment of the present invention, the POE oil is a mixture of different POE oils. In one embodiment of the present invention, the POE oil is formulated using one or more C5-C10 carboxylic acids.

Hydrocarbon lubricating oils of the present invention may comprise those commonly known as “mineral oils” in the field of compression refrigeration lubrication, Mineral oils comprise paraffins (i.e. straight-chain and branched-carbon-chain, saturated hydrocarbons), naphthenes (i.e. cyclic paraffins) and aromatics (i.e. unsaturated, cyclic hydrocarbons containing one or more rings characterized by alternating double bonds). Hydrocarbon lubricating oils of the present invention further comprise those commonly known as “synthetic oils” in the field of compression refrigeration lubrication. Synthetic oils comprise alkylaryls (i.e. linear and branched alkyl alkylbenzenes), synthetic paraffins and napthenes, and poly(alphaolefins).

Traditional classification of oils as paraffinic or naphthenic refers to the number of paraffinic or naphthenic molecules in the refined lubricant. Paraffinic crudes contain a higher proportion of paraffin wax, and thus have a higher viscosity index and pour point than to naphthenic crudes.

Alkylbenzene lubricating oils have alkyl side chains that are either branched or linear, with a distribution in chain lengths typically from 10 to 20 carbons, though other alkyl chain length distributions are possible. Another preferred alkylbenzene lubricating oil comprises at least one alkylbenzene of the form: (C₆H₆)—C(CH₂)(R₁)(R₂) where (C₆H₆) is a benzyl ring and R₁ and R₂ are saturated alkyl groups, preferably containing at least one isoC₃ group, more preferably from 1 to 6 isoC₃ groups. Either R₁ or R₂ may be a hydrogen atom, but preferably not both.

PAG oils can be ‘un-capped’, ‘single-end capped’, or ‘double-end capped’. Examples of commercial PAG oils include, but are not limited to, ND-8, Castrol PAG 46, Castrol PAG 100, Castrol PAG 150, Daphne Hermetic PAG PL, Daphne Hermetic PAG PR.

Polyvinyl ether (PVE) oils are another type of oxygenated refrigeration oil that has been developed for use with HFC refrigerants. Commercial examples of PVE refrigeration oil include FVC32D and FVC68D produced by Idemitsu. Though not meant to limit the scope of the present invention in any way, in an embodiment of the present invention, the polyvinyl ether oil includes those taught in the literature such as described in U.S. Pat. Nos. 5,399,631 and 6,454,960. In another embodiment of the present invention, the polyvinyl ether oil is composed of structural units of the type shown by Formula 1:

—[C(R₁,R₂)—C(R₃,—O—R₄)]— Formula 1

Where R₁, R₂, R₃, and R₄ are independently selected from hydrogen and hydrocarbons, where the hydrocarbons may optionally contain one or more ether groups. In a preferred embodiment of the present invention, R₁, R₂ and R₃ are each hydrogen, as shown in Formula 2:

—[CH₂—CH(—O—R₄)]— Formula 2

In another embodiment of the present invention, the polyvinyl ether oil is composed of structural units of the type shown by Formula 3:

—[CH₂—CH(—O—R₅)]ₘ—[CH₂—CH(—O—R₆)]ₙ— Formula 3

Where R₅ and R₆ are independently selected from hydrogen and hydrocarbons and where m and n are integers.

The thermal/chemical stability of refrigerant/lubricant mixtures can be evaluated using various tests known to those of skill the art, such as ANSI/ASHRAE Standard 97-2007 (ASHRAE 97). In such a test, mixtures of refrigerant and lubricant, optionally in the presence of catalyst or other materials including water, air, metals, metal oxides, ceramics, etc, are typically aged at elevated temperature for a predetermined aging period. After aging the mixture is analyzed to evaluate any decomposition or degradation of the mixture. A typical composition for testing is a 50/50 wt/wt mixture of refrigerant/lubricant, though other compositions can be used. Typically, the aging conditions are at from about 140° C. to 200° C. for from 1 to 30 days; aging at 175° C. for 14 days is very typical.

Multiple techniques are typically used to analysis the mixtures following agent. A visual inspection of the liquid fraction of the mixture for any signs of color change, precipitation, or heavies, is used to check for gross decomposition of either the refrigerant or lubricant. Visual inspection of any metal test pieces used during testing is also done to check for signs of corrosion, deposits, etc. Halide analysis is typically performed on the liquid fraction to quantify the concentration of halide ions (e.g., fluoride) present. An increase in the halide concentration indicates a greater fraction of the halogenated refrigerant has degraded during aging and is a sign of decreased stability. The Total Acid Number (TAN) for the liquid fraction is typically measured to determine the acidity of the recovered liquid fraction, where an increase in acidity is a sign of decomposition of the refrigerant, lubricant, or both. GC-MS is typically performed on the vapor fraction of the sample to identify and quantify decomposition products.

The effect of water on the stability of the refrigerant/lubricant combination can be evaluated by performing the aging tests at various levels of moisture ranging from very dry (<10 ppm water) to very wet (>10000 ppm water). Oxidative stability can be evaluated by performing the aging test either in the presence or absence of air.

The heat transfer compositions of the present invention may be used in combination with dyes, stabilizers, acid scavengers, radical scavengers, antioxidant, viscosity modifiers, pour point depressants, corrosion inhibitors, nanoparticles, surfactants, compatibilizers, solubilizing agents, dispersing agents, fire retarding agents, flame suppressants, medicants, sterilants, polyols, polyol premix components, cosmetics, cleaners, flushing agents, anti-foaming agents, oils, odorants, tracer compounds, and mixtures thereof.

The heat transfer compositions of the present invention may be used in heat transfer systems, including for refrigeration, air conditioning, and liquid chilling. Heat transfer systems are operated with one portion of the cycle at a the lower operating temperature range and another part of the cycle at the upper operating temperature range. These upper and lower temperature ranges will depend on the specific application. For example, the operating temperatures for low temperature refrigeration may be different than for automotive air conditioning or for water chillers. Preferably, the upper operating temperature range is from about +15° C. to about +90° C., more preferably from about +30° C. to about +70° C. Preferably, the lower operating temperature range is from about +25° C. to about −60° C., more preferably from about +15° C. to about −30° C. For example, a low pressure liquid chiller may be operated at an evaporator temperature from about −10° C. to +10° C. and a condensor temperature from about +30° C. to +55° C. For example, an air conditioner, such as for automotive AC, may operate with an evaporating temperature at 4° C. and a condensing temperature of 40° C. For refrigeration, the lower operating temperature range may depend upon the specific application. For instance, some typical application temperatures for refrigeration include: freezer (e.g., ice cream): −15° F. +/−2° F. (−26° C. +/−1.1° C.); low temperature: 0° F. +/−2° F. (−18° C. +/−1.1° C.); medium temperature; 38° F. +/−2° F. (3.3° C. +/−1.1° C.). These examples are only informative and not meant to limit the scope of the present invention in any way. Other operating temperatures and operating temperature ranges may be employed within the scope of the present invention.

The heat transfer compositions of the present invention are also useful in heat recovery and organic Rankine cycles for electricity production.

Though not meant to limit the scope of this invention in any way, the heat transfer compositions of the present invention are useful in new refrigeration, air conditioning, heat pump, or other heat transfer equipment; in another embodiment, the heat transfer compositions of the present invention are useful as retrofits for refrigerants in existing equipment including, but not limited to, R-22, R-407C, R-427A, R-404A, R-407A, R-407F, R-410A, R-417A, R-422D, R-134a and others. When the heat transfer compositions of the present invention are used as retrofits for other refrigerants in existing equipment, it is preferred that the operating characteristic, such as pressures, discharge temperature, mass flow rate, are similar to the operating characteristics of the refrigerant being replaced. In a higherly preferred embodiment, the heat transfer compositions of the present invention have operating characteristics that are close enough to the refrigerant being replaced to avoid the need to change make additional changes to the equipment, such as changing a thermostatic expansion valve (TXV).

### Methods And Systems

The compositions of the present invention are useful in connection with numerous methods and systems, including as heat transfer fluids in methods and systems for transferring heat, such as refrigerants used in refrigeration, air conditioning and heat pump systems, chillers, automotive air conditioning, organic rankine cycle systems, and other heat transfer applications. The present compositions are also advantageous for in use in systems and methods of generating aerosols, preferably comprising or consisting of the aerosol propellant in such systems and methods. Methods of forming foams and methods, of extinguishing and suppressing fire are also included in certain aspects of the present invention. The present invention also provides in certain aspects methods of removing residue from articles in which the present compositions are used as solvent compositions in such methods and systems.

### Heat Transfer Methods

The preferred heat transfer methods generally comprise providing a composition of the present invention and causing heat to be transferred to or from the composition changing the phase of the composition. For example, the present methods provide cooling by absorbing heat from a fluid or article, preferably by evaporating the present refrigerant composition in the vicinity of the body or fluid to be cooled to produce vapor comprising the present composition. Preferably the methods include the further step of compressing the refrigerant vapor, usually with a compressor or similar equipment to produce vapor of the present composition at a relatively elevated pressure. Generally, the step of compressing the vapor results in the addition of heat to the vapor, thus causing an increase in the temperature of the relatively high-pressure vapor. Preferably, the present methods include removing from this relatively high temperature, high pressure vapor at least a portion of the heat added by the evaporation and compression steps. The heat removal step preferably includes condensing the high-temperature, high-pressure vapor while the vapor is in a relatively high-pressure condition to produce a relatively high-pressure liquid comprising a composition of the present invention. This relatively high-pressure liquid preferably then undergoes a nominally isoenthalpic reduction in pressure to produce a relatively low temperature, low-pressure liquid. In such embodiments, it is this reduced temperature refrigerant liquid which is then vaporized by heat transferred from the body or fluid to be cooled.

In another process embodiment of the invention, the compositions of the invention may be used in a method for producing heating which comprises condensing a refrigerant comprising the compositions in the vicinity of a liquid or body to be heated. Such methods, as mentioned hereinbefore, frequently are reverse cycles to the refrigeration cycle described above.

The heat transfer combinations of the present invention are effective working fluids in refrigeration, air-conditioning, or heat pump systems. Typical vapor-compression refrigeration, air-conditioning, or heat pump systems include an evaporator, a compressor, a condenser, and an expansion device. A vapor-compression cycle re-uses refrigerant in multiple steps producing a cooling effect in one step and a heating effect in a different step. The cycle can be described simply as follows: liquid refrigerant enters an evaporator through an expansion device, and the liquid refrigerant boils in the evaporator at a low temperature to form a gas and produce cooling. The low-pressure gas enters a compressor where the gas is compressed to raise its pressure and temperature. The higher-pressure (compressed) gaseous refrigerant then enters the condenser in which the refrigerant condenses and discharges its heat to the environment. The refrigerant returns to the expansion device through which the liquid expands from the higher-pressure level in the condenser to the low-pressure level in the evaporator, thus repeating the cycle.

The heat transfer combinations of the present invention are useful in mobile or stationary systems. Stationary air-conditioning and heat pumps include, but are not limited to chillers, high temperature heat pumps, residential and light commercial and commercial air-conditioning systems. Stationary refrigeration applications include, but are not limited to, equipment such as domestic refrigerators, ice machines, walk-in and reach-in coolers and freezers, and supermarket systems. As used herein, mobile refrigeration systems or mobile air-conditioning systems refers to any refrigeration or air-conditioning apparatus incorporated into a transportation unit for the road, rail, sea or air. The present invention is particularly useful for road transport refrigerating or air-conditioning apparatus, such as automobile air-conditioning apparatus or refrigerated road transport equipment.

Typical compressors used in refrigeration, air-conditioning, or heat pump systems are positive-displacement and dynamic compressors. Positive-displacement compressors include reciprocating compressors, such as piston compressors, orbiting compressors, such as scroll compressors, and rotary compressors, such as screw compressors. A typical dynamic compressor is a centrifugal compressor. The heat transfer compositions of the present invention can be used in heat transfer equipment employing any of these compressor types.

Refrigeration, air-conditioning, or heat pump systems may use single-staged, double-staged, or multi-staged compression. Refrigeration, aft-conditioning, or heat pump systems may also be cascade systems with or without a secondary heat transfer circuit.

Heat exchangers used in the heat transfer systems may be of any type. Typical heat exchangers include parallel or co-current flow, counterflow, cross-flow. Preferably, heat exchangers used with the heat transfer compositions of the present invention are counterflow, counterflow-like, or crossflow.

The heat transfer combinations of the present invention can be employed as a replacement for an existing heat transfer fluid/combinations an existing system or can be used as the original heat transfer combination in a new system. Such new systems can be existing new system, or system having components designed specifically to operate with the heat transfer combinations of the present invention.

### Propellant and Aerosol Compositions

In another aspect, the present invention provides propellant compositions comprising or consisting essentially of a composition of the present invention, such propellant composition preferably being a sprayable composition. The propellant compositions of the present invention preferably comprise a material to be sprayed and a propellant comprising, consisting essentially of, or consisting of a composition in accordance with the present invention. Inert ingredients, solvents, and other materials may also be present in the sprayable mixture. Preferably, the sprayable composition is an aerosol. Suitable materials to be sprayed include, without limitation, cosmetic materials such as deodorants, perfumes, hair sprays, cleansers, and polishing agents as well as medicinal materials such as anti-asthma components, anti-halitosis components and any other medication or the like, including preferably any other medicament or agent intended to be inhaled. The medicament or other therapeutic agent is preferably present in the composition in a therapeutic amount, with a substantial portion of the balance of the composition comprising a composition of the present invention.

Aerosol products for industrial, consumer or medical use typically contain one or more propellants along with one or more active ingredients, inert ingredients or solvents. The propellant provides the force that expels the product in aerosolized form. While some aerosol products are propelled with compressed gases like carbon dioxide, nitrogen, nitrous oxide and even air, most commercial aerosols use liquefied gas propellants. The most commonly used liquefied gas propellants are hydrocarbons such as butane, isobutane, and propane. Dimethyl ether and HFC-152a (1,1-difluoroethane) are also used, either alone or in blends with the hydrocarbon propellants. Unfortunately, all of these liquefied gas propellants are highly flammable and their incorporation into aerosol formulations will often result in flammable aerosol products. The present invention provides liquefied gas propellants and aerosols for certain applications that are non-flammable or have reduced flammability.

### Blowing Agents, Foams and Foamable Compositions

Blowing agents may also comprise or constitute one or more of the compositions of the present invention. In certain preferred embodiments, the blowing agent comprises at least about 50% by weight of the present compositions, and in certain embodiments the blowing agent consists essentially of the present compositions. In certain preferred embodiments, the blowing agent compositions of the present invention include, in addition to compositions of the present invention, one or more of co-blowing agents, fillers, vapor pressure modifiers, flame suppressants, stabilizers and like adjuvants.

In other embodiments, the invention provides foamable compositions. The foamable compositions of the present invention generally include one or more components capable of forming foam having a generally cellular structure and a blowing agent in accordance with the present invention. In certain embodiments, the one or more components comprise a thermosetting composition capable of forming foam and/or foamable compositions. Examples of thermosetting compositions include polyurethane and polyisocyanurate foam compositions, and also phenolic foam compositions. In such thermosetting foam embodiments, one or more of the present compositions are included as or part of a blowing agent in a foamable composition, or as a part of a two or more part foamable composition, which preferably includes one or more of the components capable of reacting and/or foaming under the proper conditions to form a foam or cellular structure. In certain other embodiments, the one or more components comprise thermoplastic materials, particularly thermoplastic polymers and/or resins. Examples of thermoplastic foam components include polyolefins, such as polystyrene (PS), polyethylene (PE), polypropylene (PP) and polyethyleneterepthalate (PET), and foams formed there from, preferably low-density foams. In certain embodiments, the thermoplastic foamable composition is an extrudable composition.

The invention also relates to foam, and preferably closed cell foam, prepared from a polymer foam formulation containing a blowing agent comprising the compositions of the invention. In yet other embodiments, the invention provides foamable compositions comprising thermoplastic or polyolefin foams, such as polystyrene (PS), polyethylene (PE), polypropylene (PP), styrene-acrylonitrile copolymers, and polyethyleneterpthalate (PET) foams, preferably low-density foams.

It will be appreciated by those skilled in the art, especially in view of the disclosure contained herein, that the order and manner in which the blowing agent of the present invention is formed and/or added to the foamable composition does not generally affect the operability of the present invention. For example, in the case of extrudable foams, it is possible that the various components of the blowing agent, and even the components of the present composition, be not be mixed in advance of introduction to the extrusion equipment, or even that the components are not added to the same location in the extrusion equipment. Thus, in certain embodiments it may be desired to introduce one or more components of the blowing agent at first location in the extruder, which is upstream of the place of addition of one or more other components of the blowing agent, with the expectation that the components will come together in the extruder and/or operate more effectively in this manner. Nevertheless, in certain embodiments, two or more components of the blowing agent are combined in advance and introduced together into the foamable composition, either directly or as part of premix which is then further added to other parts of the foamable composition.

In certain preferred embodiments, dispersing agents, cell stabilizers, surfactants and other additives may also be incorporated into the blowing agent compositions of the present invention. Surfactants are optionally but preferably added to serve as cell stabilizers. Some representative materials are sold under the names of DC-193, B-8404, and L-5340 which are, generally, polysiloxane polyoxyalkylene block copolymers such as those disclosed in U.S. Pat. Nos. 2,834,748, 2,917,480, and 2,846,458, each of which is incorporated herein by reference. Other optional additives for the blowing agent mixture may include flame retardants such as tri(2-chloroethyl)phosphate, tri(2-chloropropyl)phosphate, tri(2,3-dibromopropyl)-phosphate, tri(1,3-dichloropropyl) phosphate, diammonium phosphate, various halogenated aromatic compounds, antimony oxide, aluminum trihydrate, polyvinyl chloride, and the like.

Any of the methods well known in the art, such as those described in “Polyurethanes Chemistry and Technology,” Volumes I and II, Saunders and Frisch, 1962, John Wiley and Sons, New York, N.Y., which is incorporated herein by reference, may be used or adapted for use in accordance with the foam embodiments of the present invention.

One embodiment of the present invention relates to methods of forming polyurethane and polyisocyanurate foams. The methods generally comprise providing a blowing agent composition of the present inventions, adding (directly or indirectly) the blowing agent composition to a foamable composition, and reacting the foamable composition under the conditions effective to form a foam or cellular structure, as is well known in the art. Any of the methods well known in the art, such as those described in “Polyurethanes Chemistry and Technology, ” Volumes I and II, Saunders and Frisch, 1962, John Wiley and Sons, New York, N.Y., which is incorporated herein by reference, may be used or adapted for use in accordance with the foam embodiments of the present invention. In general, such preferred methods comprise preparing polyurethane or polyisocyanurate foams by combining an isocyanate, a polyol or mixture of polyols, a blowing agent or mixture of blowing agents comprising one or more of the present compositions, and other materials such as catalysts, surfactants, and optionally, flame retardants, colorants, or other additives. It is convenient in many applications to provide the components for polyurethane or polyisocyanurate foams in pre-blended formulations,

Most typically, the foam formulation is pre-blended into two components. The isocyanate and optionally certain surfactants and blowing agents comprise the first component, commonly referred to as the “A” component,

The polyol or polyol mixture, surfactant, catalysts, blowing agents, flame retardant, and other isocyanate reactive components comprise the second component, commonly referred to as the “B” component. Accordingly, polyurethane or polyisocyanurate foams are readily prepared by bringing together the A and B side components either by hand mix for small preparations and, preferably, machine mix techniques to form blocks, slabs, laminates, pour-in-place panels and other items, spray applied foams; froths, and the like. Optionally, other ingredients such as fire retardants, colorants, auxiliary blowing agents, and even other polyols can be added as a third stream to the mix head or reaction site. Most preferably, however, they are all incorporated into one B-component as described above.

### Cleaning Methods

The present invention also provides methods of removing contaminants from a product, part, component, substrate, or any other article or portion thereof by applying to the article a composition of the present invention. For the purposes of convenience, the term “article” is used herein to refer to all such products, parts, components, substrates, and the like and is further intended to refer to any surface or portion thereof. Furthermore, the term “contaminant” is intended to refer to any unwanted material or substance present on the article, even if such substance is placed on the article intentionally. For example, in the manufacture of semiconductor devices it is common to deposit a photoresist material onto a substrate to form a mask for the etching operation and to subsequently remove the photoresist material from the substrate. The term “contaminant” as used herein is intended to cover and encompass such a photo resist material.

Preferred methods of the present invention comprise applying the present composition to the article. Although it is contemplated that numerous and varied cleaning techniques can employ the compositions of the present invention to good advantage, it is considered to be particularly advantageous to use the present compositions in connection with supercritical cleaning techniques. Supercritical cleaning is disclosed in U.S. Pat. No. 6,589,355, which is assigned to the assignee of the present invention and incorporated herein by reference. For supercritical cleaning applications, it is preferred in certain embodiments to include in the present cleaning compositions, in addition to the compositions of the present invention, one or more additional components, such as CO2 and other additional components known for use in connection with supercritical cleaning applications. It may also be possible and desirable in certain embodiments to use the present cleaning compositions in connection with particular vapor degreasing and solvent cleaning methods.

### Sterilization Methods

Many articles, devices and materials, particularly for use in the medical field, must be sterilized prior to use for the health and safety reasons, such as the health and safety of patients and hospital staff. The present invention provides methods of sterilizing comprising contacting the articles, devices or material to be sterilized with a compound or composition of the present invention, in combination with one or more sterilizing agents. While many sterilizing agents are known in the art and are considered to be adaptable for use in connection with the present invention, in certain preferred embodiments sterilizing agent comprises ethylene oxide, formaldehyde, hydrogen peroxide, chlorine dioxide, ozone and combinations of these. In certain embodiments, ethylene oxide is the preferred sterilizing agent. Those skilled in the art, in view of the teachings contained herein, will be able to readily determine the relative proportions of sterilizing agent and the present compound(s) be used in connection with the present sterilizing compositions and methods, and all such ranges are within the broad scope hereof. As is known to those skilled in the art, certain sterilizing agents, such as ethylene oxide, are relatively flammable components, and the compound(s) accordance with the present invention are included in the present compositions in amounts effective, together with other components present in the composition, to reduce the flammability of the sterilizing composition to acceptable levels.

The sterilization methods of the present invention may be either high or low-temperature sterilization of the present invention involves the use of a compound or composition of the present invention at a temperature of from about 250° F. to about 270° F., preferably in a substantially sealed chamber. The process can be completed usually in less than about 2 hours. However, some articles, such as plastic articles and electrical components, cannot withstand such high temperatures and require low-temperature sterilization. In low temperature sterilization methods, the article to be sterilized is exposed to a fluid comprising a composition of the present invention at a temperature of from about room temperature to about 200° F., more preferably at a temperature of from about room temperature to about 100° F.

The low-temperature sterilization of the present invention is preferably at least a two-step process performed in a substantially sealed, preferably air tight, chamber. In the first step (the sterilization step), the articles having been cleaned and wrapped in gas permeable bags are placed in the chamber. Air is then evacuated from the chamber by pulling a vacuum and perhaps by displacing the air with steam. In certain embodiments, it is preferable to inject steam into the chamber to achieve a relative humidity that ranges preferably from about 30% to about 70%.

Such humidities may maximize the sterilizing effectiveness of the sterilant, which is introduced into the chamber after the desired relative humidity is achieved. After a period of time sufficient for the sterilant to permeate the wrapping and reach the interstices of the article, the sterilant and steam are evacuated from the chamber.

In the preferred second step of the process (the aeration step), the articles are aerated to remove sterilant residues. Removing such residues is particularly important in the case of toxic sterilants, although it is optional in those cases in which the substantially non-toxic compounds of the present invention are used. Typical aeration processes include air washes, continuous aeration, and a combination of the two. An air wash is a batch process and usually comprises evacuating the chamber for a relatively short period, for example, 12 minutes, and then introducing air at atmospheric pressure or higher into the chamber. This cycle is repeated any number of times until the desired removal of sterilant is achieved.

Continuous aeration typically involves introducing air through an inlet at one side of the chamber and then drawing it out through an outlet on the other side of the chamber by applying a slight vacuum to the outlet.

The following non-limiting examples are hereby provided as reference.

Table 1 sets out the chemical names and formulas for the materials used in the examples as set out in Tables 2, 3, 4, 5, 6 and 7.

TABLE 1
Components

| Compound | Chemical name | Chemical formula |
|---|---|---|
| HCFO-1122a | 1-chloro-1,2-difluoroethylene | CClF═CHF |
| HFO-1123 | 1,1,2-trifluoroethene | CF₂═CHF |
| HFO-1132a | 1,1,-difluoroethylene | CF₂═CH₂ |
| HFO-1132(E) | 1,2-difluoroethylene | (E)-CHF═CHF |
| HCFO- | (Z)-1-chloro-2,3,3,3- | (Z)-CF₃CF═CHCl |
| 1224yd(Z) | tetrafluoropropene | |
| HFO-1234yf | 2,3,3,3-tetrafluoropropene | CF₃CF═CH₂ |
| HFO-1234ze(E) | (E)-1,3,3,3-tetrafluoropropene | CF3CH═CHF |
| HFO- | (E)-1,1,1,4,4,4- | (E)- |
| 1336mzz(E) | hexafluoro-2-butene | CF₃CH═CHCF₃ |
| HFC-152a | 1,1-difluoroethane | CHF₂CH₃ |
| HFC-32 | difluoromethane | CH₂F₂ |
| HFC-134a | 1,1,1,2-tetrafluoroethane | CF₃CH₂F |
| HFC-134 | 1,1,2,2-tetrafluoroethane | CHF₂CHF₂ |
| HFC-125 | pentafluoroethane | CF₃CHF₂ |
| HFC-227ea | 1,1,1,2,3,3,3-heptafluoropropane | CF₃CHFCF₃ |
| CO₂ | carbon dioxide | CO₂ |
| CF₃I | Trifluoroiodomethane | CF₃I |
| | Propane | CH₃CH₂CH₃ |
| | n-butane | CH₃CH₂CH₂CH₃ |
| i-butane | Isobutane | CH₃CH(CH₃)CH₃ |
| DME | Dimethylether | CH₃OCH₃ |
| NH₃ | Ammonia | NH₃ |

The following Tables set out heat transfer combinations within the scope of the present invention having Global Warming Potentials within the ranges specified. The GWP used for the components of the blends were as set out in AR4 or AR5. AR4 is the “Climate Change 2007—The Physical Science Basis Contribution of Working Group I to the Fourth Assessment Report of the IPCC (ISBN 978 0521 88009-1 Hardback; 978 0521 70596-7 Paperback). AR5 is the fifth assessment. When molecules included in both AR4 and AR5, the AR4 values were used. The GWP for molecules not included in AR4 or AR5 were estimated based on the GWP of molecules having a similar structure or values reported in the public domain.

TABLE 1
Refrigerant blend compositions with GWP ≤10

| | Concentration ranges |
|---|---|
| | (wt %) |
| | Preferred |
| HCFO-1122a/HFO-1234yf | 1-99/1-99 |
| HCFO-1122a/HFO-1234ze(E) | 1-99/1-99 |
| HCFO-1122a/CO₂ | 1-99/1-99 |
| HCFO-1122a/HFO-1123 | 1-99/1-99 |
| HCFO-1122a/HFO-1132a | 1-99/1-99 |
| HCFO-1122a/HFO-1132(E) | 1-99/1-99 |
| HCFO-1122a/CF₃I | 1-99/1-99 |
| HCFO-1122a/HFO-1336mzz(E) | 1-99/1-99 |
| HCFO-1122a/HCFO-1224yd(Z) | 1-99/1-99 |
| HCFO-1122a/HFC-152a | 96-99/1-5 |
| HCFO-1122a/propane | 1-99/1-99 |
| HCFO-1122a/n-butane | 1-99/1-99 |
| HCFO-1122a/iso-butane | 1-99/1-99 |
| HCFO-1122a/DME | 1-99/1-99 |
| HCFO-1122a/NH₃ | 1-99/1-99 |
| HCFO-1122a/CO₂/CF₃I | 1-98/1-98/1-98 |
| HCFO-1122a/HFO-1336mzz(E)/CF₃I | 1-98/1-98/1-98 |
| HCFO-1122a/HCFO-1224yd(Z)/CF₃I | 1-98/1-98/1-98 |
| HCFO-1122a/HFO-1123/CF₃I | 1-98/1-98/1-98 |
| HCFO-1122a/HFO-1132a/CF₃I | 1-98/1-98/1-98 |
| HCFO-1122a/HFO-1132(E)/CF₃I | 1-98/1-98/1-98 |
| HCFO-1122a/HFO-1234yf/CF₃I | 1-98/1-98/1-98 |
| HCFO-1122a/HFO-1234ze(E)/CF₃I | 1-98/1-98/1-98 |
| HCFO-1122a/HFO-1234yf/HFO-1234ze(E) | 1-98/1-98/1-98 |
| HCFO-1122a/Propane/CF₃I | 1-98/1-98/1-98 |
| HCFO-1122a/n-butane/CF₃I | 1-98/1-98/1-98 |
| HCFO-1122a/iso-butane/CF₃I | 1-98/1-98/1-98 |
| HCFO-1122a/DME/CF₃I | 1-98/1-98/1-98 |
| HCFO-1122a/HFO-1336mzz(E)/CO₂ | 1-98/1-98/1-98 |
| HCFO-1122a/HCFO-1224yd(Z)/CO₂ | 1-98/1-98/1-98 |
| HCFO-1122a/HFO-1123/CO₂ | 1-98/1-98/1-98 |
| HCFO-1122a/HFO-1132a/CO₂ | 1-98/1-98/1-98 |
| HCFO-1122a/HFO-1132(E)/CO₂ | 1-98/1-98/1-98 |
| HCFO-1122a/HFO-1234yf/CO₂ | 1-98/1-98/1-98 |
| HCFO-1122a/HFO-1234ze(E)/CO₂ | 1-98/1-98/1-98 |
| HCFO-1122a/DME/NH₃ | 1-98/1-98/1-98 |

TABLE 2
Refrigerant blend compositions with 10 < GWP ≤ 200

| | Concentration ranges |
|---|---|
| | (wt %) |
| | Preferred |
| HCFO-1122a/HFC-125 | 94-99/1-6 |
| HCFO-1122a/HFC-134a | 86-99/1-14 |
| HCFO-1122a/HFC-134 | 82-99/1-18 |
| HCFO-1122a/HFC-32 | 71-99/1-29 |
| HCFO-1122a/HFC-152a | 1-95/5-99 |
| HCFO-1122a/HFC-227ea | 95-99/1-6 |
| HCFO-1122a/HFC-125/HFC-227ea | 88-98/1-6/1-6 |
| HCFO-1122a/HFC-125/HFC-32 | 70-98/1-6/1-24 |
| HCFO-1122a/HFC-125/HFC-134a | 83-98/1-6/1-11 |
| HCFO-1122a/HFC-125/HFC-134 | 79-98/1-6/1-15 |
| HCFO-1122a/HFC-125/HFC-152a | 1-98/1-6/1-98 |
| HCFO-1122a/HFC-125/CF₃I | 1-98/1-6/1-98 |
| HCFO-1122a/HFC-227ea/HFC-32 | 70-98/1-6/1-24 |
| HCFO-1122a/HFC-227ea/HFC-134a | 83-98/1-6/1-11 |
| HCFO-1122a/HFC-227ea/HFC-134 | 79-98/1-6/1-15 |
| HCFO-1122a/HFC-227ea/HFC-152a | 1-98/1-6/1-98 |
| HCFO-1122a/HFC-227ea/CF₃I | 1-98/1-6/1-98 |
| HCFO-1122a/HFO-1123/HFC-125 | 1-98/1-98/1-6 |
| HCFO-1122a/HFO-1123/HFC-134a | 1-98/1-98/1-14 |
| HCFO-1122a/HFO-1123/HFC-134 | 1-98/1-98/1-18 |
| HCFO-1122a/HFO-1123/HFC-32 | 1-98/1-98/1-29 |
| HCFO-1122a/HFO-1123/HFC-152a | 1-94/1-94/5-98 |
| HCFO-1122a/HFO-1123/HFC-227ea | 1-98/1-98/1-6 |
| HCFO-1122a/HFO-1132a/HFC-125 | 1-98/1-98/1-6 |
| HCFO-1122a/HFO-1132a/HFC-134a | 1-98/1-98/1-14 |
| HCFO-1122a/HFO-1132a/HFC-134 | 1-98/1-98/1-18 |
| HCFO-1122a/HFO-1132a/HFC-32 | 1-98/1-98/1-29 |
| HCFO-1122a/HFO-1132a/HFC-152a | 1-94/1-94/5-98 |
| HCFO-1122a/HFO-1132a/HFC-227ea | 1-98/1-98/1-6 |
| HCFO-1122a/HFO-1132(E)/HFC-125 | 1-98/1-98/1-6 |
| HCFO-1122a/HFO-1132(E)/HFC-134a | 1-98/1-98/1-14 |
| HCFO-1122a/HFO-1132(E)/HFC-134 | 1-98/1-98/1-18 |
| HCFO-1122a/HFO-1132(E)/HFC-32 | 1-98/1-98/1-29 |
| HCFO-1122a/HFO-1132(E)/HFC-152a | 1-94/1-94/5-98 |
| HCFO-1122a/HFO-1132(E)/HFC-227ea | 1-98/1-98/1-6 |
| HCFO-1122a/HFO-1224yd(Z)/HFC-125 | 1-98/1-98/1-6 |
| HCFO-1122a/HCFO-1224yd(Z)/HFC-134a | 1-98/1-98/1-14 |
| HCFO-1122a/HCFO-1224yd(Z)/HFC-134 | 1-98/1-98/1-18 |
| HCFO-1122a/HCFO-1224yd(Z)/HFC-32 | 1-98/1-98/1-29 |
| HCFO-1122a/HCFO-1224yd(Z)/HFC-152a | 1-98/1-98/5-98 |
| HCFO-1122a/HFO-1224yd(Z)/HFC-227ea | 1-98/1-98/1-6 |
| HCFO-1122a/HFO-1234yf/HFC-125 | 1-98/1-98/1-6 |
| HCFO-1122a/HFO-1234yf/HFC-134a | 1-98/1-98/1-14 |
| HCFO-1122a/HFO-1234yf/HFC-134 | 1-98/1-98/1-18 |
| HCFO-1122a/HFO-1234yf/HFC-32 | 1-98/1-98/1-29 |
| HCFO-1122a/HFO-1234yf/HFC-152a | 1-98/1-98/5-98 |
| HCFO-1122a/HFO-1234yf/HFC-227ea | 1-98/1-98/1-6 |
| HCFO-1122a/HFO-1234ze(E)/HFC-125 | 1-98/1-98/1-6 |
| HCFO-1122a/HFO-1234ze(E)/HFC-134a | 1-98/1-98/1-14 |
| HCFO-1122a/HFO-1234ze(E)/HFC-134 | 1-98/1-98/1-18 |
| HCFO-1122a/HFO-1234ze(E)/HFC-32 | 1-98/1-98/1-29 |
| HCFO-1122a/HFO-1234ze(E)/HFC-227ea | 1-98/1-98/1-6 |
| HCFO-1122a/HFO-1234ze(E)/HFC-152a | 1-98/1-98/5-98 |
| HCFO-1122a/HFO-1336mzz(E)/HFC-125 | 1-98/1-98/1-6 |
| HCFO-1122a/HFO-1336mzz(E)/HFC-134a | 1-98/1-98/1-14 |
| HCFO-1122a/HFO-1336mzz(E)/HFC-134 | 1-98/1-98/1-18 |
| HCFO-1122a/HFO-1336mzz(E)/HFC-32 | 1-98/1-98/1-29 |
| HCFO-1122a/HFO-1336mzz(E)/HFC-152a | 1-98/1-98/5-98 |
| HCFO-1122a/HFO-1336mzz(E)/HFC-227ea | 1-98/1-98/1-6 |
| HCFO-1122a/CO₂/HFC-125 | 1-98/1-98/1-6 |
| HCFO-1122a/CO₂/HFC-134a | 1-98/1-98/1-14 |
| HCFO-1122a/CO₂/HFC-134 | 1-98/1-98/1-18 |
| HCFO-1122a/CO₂/HFC-32 | 1-98/1-98/1-29 |
| HCFO-1122a/CO₂/HFC-152a | 1-98/1-98/5-98 |
| HCFO-1122a/CO₂/HFC-227ea | 1-98/1-98/1-6 |
| HCFO-1122a/CF₃I/HFC-125 | 1-98/1-98/1-6 |
| HCFO-1122a/CF₃I/HFC-134a | 1-98/1-98/1-14 |
| HCFO-1122a/CF₃I/HFC-134 | 1-98/1-98/1-18 |
| HCFO-1122a/CF₃I/HFC-32 | 1-98/1-98/1-29 |
| HCFO-1122a/CF₃I/HFC-152a | 1-98/1-98/5-98 |
| HCFO-1122a/CF₃I/HFC-227ea | 1-98/1-98/1-6 |
| HCFO-1122a/Propane/HFC-125 | 1-98/1-98/1-6 |
| HCFO-1122a/Propane/HFC-134a | 1-98/1-98/1-14 |
| HCFO-1122a/Propane/HFC-134 | 1-98/1-98/1-18 |
| HCFO-1122a/Propane/HFC-32 | 1-98/1-98/1-29 |
| HCFO-1122a/Propane/HFC-152a | 1-98/1-98/5-98 |
| HCFO-1122a/Propane/HFC-227ea | 1-98/1-98/1-6 |
| HCFO-1122a/n-butane/HFC-125 | 1-98/1-98/1-6 |
| HCFO-1122a/n-butane/HFC-134a | 1-98/1-98/1-14 |
| HCFO-1122a/n-butane/HFC-134 | 1-98/1-98/1-18 |
| HCFO-1122a/n-butane/HFC-32 | 1-98/1-98/1-29 |
| HCFO-1122a/n-butane/HFC-152a | 1-98/1-98/5-98 |
| HCFO-1122a/n-butane/HFC-227ea | 1-98/1-98/1-6 |
| HCFO-1122a/isobutane/HFC-125 | 1-98/1-98/1-6 |
| HCFO-1122a/isobutane/HFC-134a | 1-98/1-98/1-14 |
| HCFO-1122a/isobutane/HFC-134 | 1-98/1-98/1-18 |
| HCFO-1122a/isobutane/HFC-32 | 1-98/1-98/1-29 |
| HCFO-1122a/isobutane/HFC-152a | 1-98/1-98/5-98 |
| HCFO-1122a/isobutane/HFC-227ea | 1-98/1-98/1-6 |
| HCFO-1122a/DME/HFC-125 | 1-98/1-98/1-6 |
| HCFO-1122a/DME/HFC-134a | 1-98/1-98/1-14 |
| HCFO-1122a/DME/HFC-134 | 1-98/1-98/1-18 |
| HCFO-1122a/DME/HFC-32 | 1-98/1-98/1-29 |
| HCFO-1122a/DME/HFC-152a | 1-98/1-98/5-98 |
| HCFO-1122a/DME/HFC-227ea | 1-98/1-98/1-6 |
| HCFO-1122a/NH₃/HFC-125 | 1-98/1-98/1-6 |
| HCFO-1122a/NH₃/HFC-134a | 1-98/1-98/1-14 |
| HCFO-1122a/NH₃/HFC-134 | 1-98/1-98/1-18 |
| HCFO-1122a/NH₃/HFC-32 | 1-98/1-98/1-29 |
| HCFO-1122a/NH₃/HFC-152a | 1-98/1-98/5-98 |
| HCFO-1122a/NH₃/HFC-227ea | 1-98/1-98/1-6 |

TABLE 3
Refrigerant blend compositions with 200 < GWP ≤ 400

| | Concentration ranges |
|---|---|
| | (wt %) |
| | Preferred |
| HCFO-1122a/HFC-125 | 88-94/6-12 |
| HCFO-1122a/HFC-134a | 72-86/14-28 |
| HCFO-1122a/HFC-134 | 64-82/18-36 |
| HCFO-1122a/HFC-32 | 41-71/29-59 |
| HCFO-1122a/HFC-227ea | 88-94/6-12 |
| HCFO-1122a/HFC-125/HFC-32 | 59-93/6-12/1-29 |
| HCFO-1122a/HFC-125/HFC-134a | 74-93/6-12/1-14 |
| HCFO-1122a/HFC-125/HFC-134 | 70-93/6-12/1-18 |
| HCFO-1122a/HFC-125/HFC-152a | 1-93/6-12/1-93 |
| HCFO-1122a/HFC-125/HFC-227ea | 1-98/1-12/1-12 |
| HCFO-1122a/HFC-227ea/HFC-32 | 59-93/6-12/1-29 |
| HCFO-1122a/HFC-227a/HFC-134a | 74-93/6-12/1-14 |
| HCFO-1122a/HFC-227ea/HFC-134 | 70-93/6-12/1-18 |
| HCFO-1122a/HFC-227ea/HFC-152a | 1-93/6-12/1-93 |
| HCFO-1122a/HFO-1123/HFC-125 | 1-93/1-93/6-12 |
| HCFO-1122a/HFO-1123/HFC-134a | 1-85/1-85/14-28 |
| HCFO-1122a/HFO-1123/HFC-134 | 1-81/1-81/18-36 |
| HCFO-1122a/HFO-1123/HFC-32 | 1-70/1-70/29-59 |
| HCFO-1122a/HFO-1123/HFC-227ea | 1-93/1-93/6-12 |
| HCFO-1122a/HFO-1132a/HFC-125 | 1-93/1-93/6-12 |
| HCFO-1122a/HFO-1132a/HFC-134a | 1-85/1-85/14-28 |
| HCFO-1122a/HFO-1132a/HFC-134 | 1-81/1-81/18-36 |
| HCFO-1122a/HFO-1132a/HFC-32 | 1-70/1-70/29-59 |
| HCFO-1122a/HFO-1132a/HFC-227ea | 1-93/1-93/6-12 |
| HCFO-1122a/HFO-1132(E)/HFC-125 | 1-93/1-93/6-12 |
| HCFO-1122a/HFO-1132(E)/HFC-134a | 1-85/1-85/14-28 |
| HCFO-1122a/HFO-1132(E)/HFC-134 | 1-81/1-81/18-36 |
| HCFO-1122a/HFO-1132(E)/HFC-32 | 1-70/1-70/29-59 |
| HCFO-1122a/HFO-1132(E)/HFC-227ea | 1-93/1-93/6-12 |
| HCFO-1122a/HFO-1124yd(Z)/HFC-125 | 1-93/1-93/6-12 |
| HCFO-1122a/HFO-1124yd(Z)/HFC-134a | 1-85/1-85/14-28 |
| HCFO-1122a/HFO-1124yd(Z)/HFC-134 | 1-81/1-81/18-36 |
| HCFO-1122a/HFO-1124yd(Z)/HFC-32 | 1-70/1-70/29-59 |
| HCFO-1122a/HFO-1124yd(Z)/HFC-227ea | 1-93/1-93/6-12 |
| HCFO-1122a/HFO-1234yf/HFC-125 | 1-93/1-93/6-12 |
| HCFO-1122a/HFO-1234yf/HFC-134a | 1-85/1-85/14-28 |
| HCFO-1122a/HFO-1234yf/HFC-134 | 1-81/1-81/18-36 |
| HCFO-1122a/HFO-1234yf/HFC-32 | 1-70/1-70/29-59 |
| HCFO-1122a/HFO-1234yf/HFC-227ea | 1-93/1-93/6-12 |
| HCFO-1122a/HFO-1234ze(E)/HFC-125 | 1-93/1-93/6-12 |
| HCFO-1122a/HFO-1234zc(E)/HFC-134a | 1-85/1-85/14-28 |
| HCFO-1122a/HFO-1234ze(E)/HFC-134 | 1-81/1-81/18-36 |
| HCFO-1122a/HFO-1234ze(E)/HFC-32 | 1-70/1-70/29-59 |
| HCFO-1122a/HFO-1234ze(E)/HFC-227ea | 1-93/1-93/6-12 |
| HCFO-1122a/HFO-1336mzz(E)/HFC-125 | 1-93/1-93/6-12 |
| HCFO-1122a/HFO-1336mzz(E)/HFC-134a | 1-85/1-85/14-28 |
| HCFO-1122a/HFO-1336mzz(E)/HFC-134 | 1-81/1-81/18-36 |
| HCFO-1122a/HFO-1336mzz(E)/HFC-32 | 1-70/1-70/29-59 |
| HCFO-1122a/HFO-1336mzz(E)/HFC-227ea | 1-93/1-93/6-12 |
| HCFO-1122a/CO₂/HFC-125 | 1-93/1-93/6-12 |
| HCFO-1122a/CO₂/HFC-134a | 1-85/1-85/14-28 |
| HCFO-1122a/CO₂/HFC-134 | 1-81/1-81/18-36 |
| HCFO-1122a/CO₂/HFC-32 | 1-70/1-70/29-59 |
| HCFO-1122a/CO₂/HFC-227ea | 1-93/1-93/6-12 |
| HCFO-1122a/CF₃I/HFC-125 | 1-93/1-93/6-12 |
| HCFO-1122a/CF₃I/HFC-134a | 1-85/1-85/14-28 |
| HCFO-1122a/CF₃I/HFC-134 | 1-81/1-81/18-36 |
| HCFO-1122a/CF₃I/HFC-32 | 1-70/1-70/29-59 |
| HCFO-1122a/CF₃I/HFC-227ea | 1-93/1-93/6-12 |
| HCFO-1122a/propane/HFC-125 | 1-93/1-93/6-12 |
| HCFO-1122a/propane/HFC-134a | 1-85/1-85/14-28 |
| HCFO-1122a/propane/HFC-134 | 1-81/1-81/18-36 |
| HCFO-1122a/propane/HFC-32 | 1-70/1-70/29-59 |
| HCFO-1122a/propane/HFC-227ea | 1-93/1-93/6-12 |
| HCFO-1122a/n-butane/HFC-125 | 1-93/1-93/6-12 |
| HCFO-1122a/n-butane/HFC-134a | 1-85/1-85/14-28 |
| HCFO-1122a/n-butane/HFC-134 | 1-81/1-81/18-36 |
| HCFO-1122a/n-butane/HFC-227ea | 1-93/1-93/6-12 |
| HCFO-1122a/isobutane/HFC-32 | 1-70/1-70/29-59 |
| HCFO-1122a/isobutane/HFC-125 | 1-93/1-93/6-12 |
| HCFO-1122a/isobutane/HFC-134a | 1-85/1-85/14-28 |
| HCFO-1122a/isobutane/HFC-134 | 1-81/1-81/18-36 |
| HCFO-1122a/isobutane/HFC-32 | 1-70/1-70/29-59 |
| HCFO-1122a/isobutane/HFC-227ea | 1-93/1-93/6-12 |
| HCFO-1122a/DME/HFC-125 | 1-93/1-93/6-12 |
| HCFO-1122a/DME/HFC-134a | 1-85/1-85/14-28 |
| HCFO-1122a/DME/HFC-134 | 1-81/1-81/18-36 |
| HCFO-1122a/DME/HFC-32 | 1-70/1-70/29-59 |
| HCFO-1122a/DME/HFC-227ea | 1-93/1-93/6-12 |
| HCFO-1122a/NH₃/HFC-125 | 1-93/1-93/6-12 |
| HCFO-1122a/NH₃/HFC-134a | 1-85/1-85/14-28 |
| HCFO-1122a/NH₃/HFC-134 | 1-81/1-81/18-36 |
| HCFO-1122a/NH₃/HFC-32 | 1-70/1-70/29-59 |
| HCFO-1122a/NH₃/HFC-227ea | 1-93/1-93/6-12 |

TABLE 4
Refrigerant blend compositions with 400 < GWP ≤ 600

| | Concentration ranges |
|---|---|
| | (wt %) |
| | Preferred |
| HCFO-1122a/HFC-125 | 83-88/12-17 |
| HCFO-1122a/HFC-134a | 58-72/28-42 |
| HCFO-1122a/HFC-134 | 46-64/36-54 |
| HCFO-1122a/HFC-32 | 11-41/59-89 |
| HCFO-1122a/HFC-227ea | 82-88/12-18 |
| HCFO-1122a/HFC-125/HFC-32 | 1-87/12-17/1-27 |
| HCFO-1122a/HFC-125/HFC-134a | 1-87/12-17/1-13 |
| HCFO-1122a/HFC-125/HFC-134 | 1-87/12-17/1-17 |
| HCFO-1122a/HFC-125/HFC-152a | 1-87/12-17/1-87 |
| HCFO-1122a/HFC-125/HFC-227ea | 1-98/1-17/1-17 |
| HCFO-1122a/HFC-227ea/HFC-32 | 1-87/12-17/1-27 |
| HCFO-1122a/HFC-227ea/HFC-134a | 1-87/12-17/1-13 |
| HCFO-1122a/HFC-227ea/HFC-134 | 1-87/12-17/1-17 |
| HCFO-1122a/HFC-227ea/HFC-152a | 1-87/12-17/1-87 |
| HCFO-1122a/HFO-1123/HFC-125 | 1-87/1-87/12-17 |
| HCFO-1122a/HFO-1123/HFC-134a | 1-71/1-71/28-42 |
| HCFO-1122a/HFO-1123/HFC-134 | 1-63/1-63/36-54 |
| HCFO-1122a/HFO-1123/HFC-32 | 1-40/1-40/59-89 |
| HCFO-1122a/HFO-1123/HFC-227ea | 1-87/1-87/12-18 |
| HCFO-1122a/HFO-1132a/HFC-125 | 1-87/1-87/12-17 |
| HCFO-1122a/HFO-1132a/FIFC-134a | 1-71/1-71/28-42 |
| HCFO-1122a/HFO-1132a/HFC-134 | 1-63/1-63/36-54 |
| HCFO-1122a/HFO-1132a/HFC-32 | 1-40/1-40/59-89 |
| HCFO-1122a/HFO-1132a/HFC-227ea | 1-87/1-87/12-18 |
| HCFO-1122a/HFO-1132(E)/HFC-125 | 1-87/1-87/12-17 |
| HCFO-1122a/HFO-1132(E)/HFC-134a | 1-7171-71/28-42 |
| HCFO-1122a/HFO-1132(E)/HFC-134 | 1-63/1-63/36-54 |
| HCFO-1122a/HFO-1132(E)/HFC-32 | 1-40/1-40/59-89 |
| HCFO-1122a/HFO-1132(E)/HFC-227ea | 1-87/1-87/12-18 |
| HCFO-1122a/HFO-1124yd(Z)/HFC-125 | 1-87/1-87/12-17 |
| HCFO-1122a/HFO-1124yd(Z)/HFC-134a | 1-71/1-71/28-42 |
| HCFO-1122a/HFO-1124yd(Z)/HFC-134 | 1-63/1-63/36-54 |
| HCFO-1122a/HFO-1124yd(Z)/HFC-32 | 1-40/1-40/59-89 |
| HCFO-1122a/HFO-1124yd(Z)/HFC-227ca | 1-87/1-87/12-18 |
| HCFO-1122a/HFO-1234yf/HFC-125 | 1-87/1-87/12-17 |
| HCFO-1122a/HFO-1234yf/HFC-134a | 1-71/1-71/28-42 |
| HCFO-1122a/HFO-1234yf/HFC-134 | 1-63/1-63/36-54 |
| HCFO-1122a/HFO-1234yf/HFC-32 | 1-40/1-40/59-89 |
| HCFO-1122a/HFO-1234yf/HFC-227ea | 1-87/1-87/12-18 |
| HCFO-1122a/HFO-1234ze(E)/HFC-125 | 1-87/1-87/12-17 |
| HCFO-1122a/HFO-1234ze(E)/HFC-134a | 1-71/1-71/28-42 |
| HCFO-1122a/HFO-1234ze(E)/HFC-134 | 1-63/1-63/36-54 |
| HCFO-1122a/HFO-1234ze(E)/HFC-32 | 1-40/1-40/59-89 |
| HCFO-1I22a/HFO-1234ze(E)/HFC-227ea | 1-87/1-87/12-18 |
| HCFO-1122a/HFO-1336mzz(E)/HFC-125 | 1-87/1-87/12-17 |
| HCFO-1122a/HFO-1336mzz(E)/HFC-134a | 1-71/1-71/28-42 |
| HCFO-1122a/HFO-1336mzz(E)/HFC-134 | 1-63/1-63/36-54 |
| HCFO-1122a/HFO-1336mzz(E)/HFC-32 | 1-40/1-40/59-89 |
| HCFO-1122a/HFO-1336mzz(E)/HFC-227ea | 1-87/1-87/12-18 |
| HCFO-1122a/CO₂/HFC-125 | 1-87/1-87/12-17 |
| HCFO-1122a/CO₂/HFC-134a | 1-71/1-71/28-42 |
| HCFO-1122a/CO₂/HFC-134 | 1-63/1-63/36-54 |
| HCFO-1122a/CO₂/HFC-32 | 1-40/1-40/59-89 |
| HCFO-1122a/CO₂/HFC-227ea | 1-87/1-87/12-18 |
| HCFO-1122a/CF₃I/HFC-125 | 1-87/1-87/12-17 |
| HCFO-1122a/CF₃I/HFC-134a | 1-7171-71/28-42 |
| HCFO-1122a/CF₃I/HFC-134 | 1-63/1-63/36-54 |
| HCFO-1122a/CF₃I/HFC-32 | 1-40/1-40/59-89 |
| HCFO-1122a/CF₃I/HFC-227ea | 1-87/1-87/12-18 |
| HCFO-1122a/propane/HFC-125 | 1-87/1-87/12-17 |
| HCFO-1122a/propane/HFC-134a | 1-71/1-71/28-42 |
| HCFO-1122a/propane/HFC-134 | 1-63/1-63/36-54 |
| HCFO-1122a/propane/HFC-32 | 1-40/1-40/59-89 |
| HCFO-1122a/propane/HFC-227ea | 1-87/1-87/12-18 |
| HCFO-1122a/n-butane/HFC-125 | 1-87/1-87/12-17 |
| HCFO-1122a/n-butane/HFC-134a | 1-71/1-71728-42 |
| HCFO-1122a/n-butane/HFC-134 | 1-63/1-63/36-54 |
| HCFO-1122a/n-butane/HFC-32 | 1-40/1-40/59-89 |
| HCFO-1122a/n-butane/HFC-227ea | 1-87/1-87/12-18 |
| HCFO-1122a/isobutane/HFC-125 | 1-87/1-87/12-17 |
| HCFO-1122a/isobutane/HFC-134a | 1-71/1-71/28-42 |
| HCFO-1122a/isobutane/HFC-134 | 1-63/1-63/36-54 |
| HCFO-1122a/isobutane/HFC-32 | 1-40/1-40/59-89 |
| HCFO-1122a/isobutane/HFC-227ea | 1-87/1-87/12-18 |
| HCFO-1122a/DME/HFC-125 | 1-87/1-87/12-17 |
| HCFO-1122a/DME/HFC-134a | 1-71/1-71/28-42 |
| HCFO-1122a/DME/HFC-134 | 1-63/1-63/36-54 |
| HCFO-1122a/DME/HFC-32 | 1-40/1-40/59-89 |
| HCFO-1122a/DME/HFC-227ea | 1-87/1-87/12-18 |
| HCFO-1122a/NH₃/HFC-125 | 1-87/1-87/12-17 |
| HCFO-1122a/NH₃/HFC-134a | 1-71/1-71/28-42 |
| HCFO-1122a/NH₃/HFC-134 | 1-63/1-63/36-54 |
| HCFO-1122a/NH₃/HFC-32 | 1-40/1-40/59-89 |
| HCFO-1122a/NH₃/HFC-227ea | 1-87/1-87/12-18 |

TABLE 5
Refrigerant blend compositions with 600 < GWP ≤ 800

| | Concentration ranges |
|---|---|
| | (wt %) |
| | Preferred |
| HCFO-1122a/HFC-125 | 77-83/17-23 |
| HCFO-1122a/HFC-134a | 44-58/42-56 |
| HCFO-1122a/HFC-134 | 27-46/54-73 |
| HCFO-1122a/HFC-32 | 1-11/89-99 |
| HCFO-1122a/HFC-227ea | 77-83/17-25 |
| HCFO-1122a/HFC-125/HFC-32 | 1-82/17-23/1-31 |
| HCFO-1122a/HFC-125/HFC-134a | 1-82/17-23/1-15 |
| HCFO-1122a/HFC-125/HFC-134 | 1-82/17-23/1-19 |
| HCFO-1122a/HFC-125/HFC-152a | 1-82/17-23/1-82 |
| HCFO-1122a/HFC-125/HFC-227ea | 1-98/17-23/1-25 |
| HCFO-1122a/HFC-227ea/HFC-32 | 1-98/17-25/1-31 |
| HCFO-1122a/HFC-227ea/HFC-134a | 1-98/17-25/1-15 |
| HCFO-1122a/HFC-227ea/HFC-134 | 1-98/17-25/1-19 |
| HCFO-1122a/HFC-227ea/HFC-152a | 1-82/17-25/1-82 |
| HCFO-1122a/HFO-1123/HFC-125 | 1-82/1-82/17-23 |
| HCFO-1122a/HFO-1123/HFC-134a | 1-57/1-57/42-56 |
| HCFO-1122a/HFO-1123/HFC-134 | 1-45/1-45/54-73 |
| HCFO-1122a/HFO-1123/HFC-32 | 1-10/1-10/89-98 |
| HCFO-1122a/HFO-1123/HFC-227ea | 1-82/1-82/17-25 |
| HCFO-1122a/HFO-1132a/HFC-125 | 1-82/1-82/17-23 |
| HCFO-1122a/HFO-1132a/HFC-134a | 1-57/1-57/42-56 |
| HCFO-1122a/HFO-1132a/HFC-134 | 1-45/1-45/54-73 |
| HCFO-1122a/HFO-1132a/HFC-32 | 1-10/1-10/89-98 |
| HCFO-1122a/HFO-1132a/HFC-227ca | 1-82/1-82/17-25 |
| HCFO-1122a/HFO-1132(E)/HFC-125 | 1-82/1-82/17-23 |
| HCFO-1122a/HFO-1132(E)/HFC-134a | 1-57/1-57/42-56 |
| HCFO-1122a/HFO-1132(E)/HFC-134 | 1-45/1-45/54-73 |
| HCFO-1122a/HFO-1132(E)/HFC-32 | 1-10/1-10/89-98 |
| HCFO-1122a/HFO-1132(E)/HFC-227ea | 1-76/1-76/17-25 |
| HCFO-1122a/HFO-1124yd(Z)/HFC-125 | 1-76/1-76/17-23 |
| HCFO-1122a/HFO-1124yd(Z)/HFC-134a | 1-57/1-57/42-56 |
| HCFO-1122a/HFO-1124yd(Z)/HFC-134 | 1-45/1-45/54-73 |
| HCFO-1122a/HFO-1124yd(Z)/HFC-32 | 1-10/1-10/89-98 |
| HCFO-1122a/HFO-1124yd(Z)/HFC-227ea | 1-76/1-76/17-25 |
| HCFO-1122a/HFO-1234yf/HFC-125 | 1-76/1-76/17-23 |
| HCFO-1122a/HFO-I234yf/HFC-134a | 1-57/1-57/42-56 |
| HCFO-1122a/HFO-1234yf/HFC-134 | 1-45/1-45/54-73 |
| HCFO-1122a/HFO-1234yf/HFC-32 | 1-10/1-10/89-98 |
| HCFO-1122a/HFO-1234yf/HFC-227ea | 1-76/1-76/17-25 |
| HCFO-1122a/HFO-1234ze(E)/HFC-125 | 1-76/1-76/17-23 |
| HCFO-1122a/HFO-1234ze(E)/HFC-134a | 1-57/1-57/42-56 |
| HCFO-1122a/HFO-1234ze(E)/HFC-134 | 1-45/1-45/54-73 |
| HCFO-1122a/HFO-1234ze(E)/HFC-32 | 1-10/1-10/89-98 |
| HCFO-1122a/HFO-1234ze(E)/HFC-227ea | 1-76/1-76/17-25 |
| HCFO-1122a/HFO-1336mzz(E)/HFC-125 | 1-76/1-76/17-23 |
| HCFO-1122a/HFO-1336mzz(E)/HFC-134a | 1-57/1-57/42-56 |
| HCFO-1122a/HFO-1336mzz(E)/HFC-134 | 1-45/1-45/54-73 |
| HCFO-1122a/HFO-1336mzz(E)/HFC-32 | 1-10/1-10/89-98 |
| HCFO-1122a/HFO-1336mzz(E)/HFC-227ea | 1-76/1-76/17-25 |
| HCFO-1122a/CO₂/HFC-125 | 1-76/1-76/17-23 |
| HCFO-1122a/CO₂/HFC-134a | 1-57/1-57/42-56 |
| HCFO-1122a/CO₂/HFC-134 | 1-45/1-45/54-73 |
| HCFO-1122a/CO₂/HFC-32 | 1-10/1-10/89-98 |
| HCFO-1122a/CO₂/HFC-227ea | 1-76/1-76/17-25 |
| HCFO-1122a/CF₃I/HFC-125 | 1-76/1-76/17-23 |
| HCFO-1122a/CF₃I/HFC-134a | 1-57/1-57/42-56 |
| HCFO-1122a/CF₃I/HFC-134 | 1-45/1-45/54-73 |
| HCFO-1122a/CF₃I/HFC-32 | 1-10/1-10/89-98 |
| HCFO-1122a/CF₃I/HFC-227ea | 1-76/1-76/17-25 |
| HCFO-1122a/propane/HFC-125 | 1-76/1-76/17-23 |
| HCFO-1122a/propane/HFC-134a | 1-57/1-57/42-56 |
| HCFO-1122a/propane/HFC-134 | 1-45/1-45/54-73 |
| HCFO-1122a/propane/HFC-32 | 1-10/1-10/89-98 |
| HCFO-1122a/propane/HFC-227ea | 1-76/1-76/17-25 |
| HCFO-1122a/n-butane/HFC-125 | 1-76/1-76/17-23 |
| HCFO-1122a/n-butane/HFC-134a | 1-57/1-57/42-56 |
| HCFO-1122a/n-butane/HFC-134 | 1-45/1-45/54-73 |
| HCFO-1122a/n-butane/HFC-32 | 1-10/1-10/89-98 |
| HCFO-1122a/n-butane/HFC-227ea | 1-76/1-76/17-25 |
| HCFO-1122a/isobutane/HFC-125 | 1-76/1-76/17-23 |
| HCFO-1122a/isobutane/HFC-134a | 1-57/1-57/42-56 |
| HCFO-1122a/isobutane/HFC-134 | 1-45/1-45/54-73 |
| HCFO-1122a/isobutane/HFC-32 | 1-10/1-10/89-98 |
| HCFO-1122a/isobutane/HFC-227ea | 1-76/1-76/17-25 |
| HCFO-1122a/DME/HFC-125 | 1-76/1-76/17-23 |
| HCFO-1122a/DME/HFC-134a | 1-57/1-57/42-56 |
| HCFO-1122a/DME/HFC-134 | 1-45/1-45/54-73 |
| HCFO-1122a/DME/HFC-32 | 1-10/1-10/89-98 |
| HCFO-1122a/DME/HFC-227ea | 1-76/1-76/17-23 |
| HCFO-1122a/NH₃/HFC-125 | 1-76/1-76/17-23 |
| HCFO-1122a/NH₃/HFC-134a | 1-57/1-57/42-56 |
| HCFO-1122a/NH₃/HFC-134 | 1-45/1-45/54-73 |
| HCFO-1122a/NH₃/HFC-32 | 1-10/1-10/89-98 |
| HCFO-1122a/NH₃/HFC-227ea | 1-76/1-76/17-25 |

TABLE 6
Refrigerant blend compositions with 800 < GWP ≤ 1000

| | Concentration ranges |
|---|---|
| | (wt %) |
| | Preferred |
| HCFO-1122a/HFC-125 | 71-77/23-29 |
| HCFO-1122a/HFC-134a | 30-44/56-70 |
| HCFO-1122a/HFC-134 | 9-27/73-91 |
| HCFO-1122a/HFC-227ea | 69-76/24-32 |
| HCFO-1122a/HFC-125/HFC-32 | 42-76/23-29/1-29 |
| HCFO-1122a/HFC-125/HFC-134a | 57-76/23-29/1-14 |
| HCFO-1122a/HFC-125/HFC-134 | 53-76/23-29/1-18 |
| HCFO-1122a/HFC-125/HFC-152a | 1-76/23-29/1-76 |
| HCFO-1122a/HFC-125/HFC-227ea | 64-76/23-29/1-7 |
| HCFO-1122a/HFC-227ea/HFC-32 | 44-75/24-32/1-34 |
| HCFO-1122a/HFC-227ea/HFC-134a | 52-75/24-32/1-16 |
| HCFO-1122a/HFC-227ea/HFC-134 | 47-75/24-32/1-21 |
| HCFO-1122a/HFC-227ea/HFC-152a | 1-75/24-32/1-75 |
| HCFO-1122a/HFO-1123/HFC-125 | 1-76/1-76/23-29 |
| HCFO-1122a/HFO-1123/HFC-134a | 1-43/1-43/56-70 |
| HCFO-1122a/HFO-1123/HFC-134 | 1-26/1-26/73-91 |
| HCFO-1122a/HFO-1123/HFC-227ea | 1-75/1-75/24-32 |
| HCFO-1122a/HFO-1132a/HFC-125 | 1-76/1-76/23-29 |
| HCFO-1122a/HFO-1132a/HFC-134a | 1-43/1-43/56-70 |
| HCFO-1122a/HFO-1132a/HFC-134 | 1-26/1-26/73-91 |
| HCFO-1122a/HFO-1132a/HFC-227ea | 1-75/1-75/24-32 |
| HCFO-1122a/HFO-1132(E)/HFC-125 | 1-76/1-76/23-29 |
| HCFO-1122a/HFO-1132(E)/HFC-134a | 1-43/1-43/56-70 |
| HCFO-1122a/HFO-1132(E)/HFC-134 | 1-26/1-26/73-91 |
| HCFO-1122a/HFO-1132(E)/HFC-227ea | 1-75/1-75/24-32 |
| HCFO-1122a/HFO-1124yd(Z)/HFC-125 | 1-76/1-76/23-29 |
| HCFO-1122a/HFO-1124yd(Z)/HFC-134a | 1-43/1-43/56-70 |
| HCFO-1122a/HFO-1124yd(Z)/HFC-134 | 1-26/1-26/73-91 |
| HCFO-1122a/HFO-1124yd(Z)/HFC-227ea | 1-75/1-76/24-32 |
| HCFO-1122a/HFO-1234yf/HFC-125 | 1-76/1-76/23-29 |
| HCFO-1122a/HFO-1234yf/HFC-134a | 1-43/1-43/56-70 |
| HCFO-1122a/HFO-1234yf/HFC-134 | 1-26/1-26/73-91 |
| HCFO-1122a/HFO-1234yf/HFC-227ea | 1-75/1-76/24-32 |
| HCFO-1122a/HFO-1234ze(E)/HFC-125 | 1-76/1-76/23-29 |
| HCFO-1122a/HFO-1234ze(E)/HFC-134a | 1-43/1-43/56-70 |
| HCFO-1122a/HFO-1234ze(E)/HFC-134 | 1-26/1-26/73-91 |
| HCFO-1122a/HFO-1234ze(E)/HFC-227ea | 1-75/1-76/24-32 |
| HCFO-1122a/HFO-1336mzz(E)/HFC-125 | 1-76/1-76/23-29 |
| HCFO-1122a/HFO-1336mzz(E)/HFC-134a | 1-43/1-43/56-70 |
| HCFO-1122a/HFO-1336mzz(E)/HFC-134 | 1-26/1-26/73-91 |
| HCFO-1122a/HFO-1336mzz(E)/HFC-227ea | 1-75/1-76/24-32 |
| HCFO-1122a/CO₂/HFC-125 | 1-76/1-76/23-29 |
| HCFO-1122a/CO₂/HFC-134a | 1-43/1-43/56-70 |
| HCFO-1122a/CO₂/HFC-134 | 1-26/1-26/73-91 |
| HCFO-1122a/CO₂/HFC-227ea | 1-75/1-76/24-32 |
| HCFO-1122a/CF₃I/HFC-125 | 1-76/1-76/23-29 |
| HCFO-1122a/CF₃I/HFC-134a | 1-43/1-43/56-70 |
| HCFO-1122a/CF₃I/HFC-134 | 1-26/1-26/73-91 |
| HCFO-1122a/CF₃I/HFC-227ea | 1-75/1-76/24-32 |
| HCFO-1122a/propane/HFC-125 | 1-76/1-76/23-29 |
| HCFO-1122a/propane/HFC-134a | 1-43/1-43/56-70 |
| HCFO-1122a/propane/HFC-134 | 1-26/1-26/73-91 |
| HCFO-1122a/propane/HFC-227ea | 1-75/1-76/24-32 |
| HCFO-1122a/n-butane/HFC-125 | 1-76/1-76/23-29 |
| HCFO-1122a/n-butane/HFC-134a | 1-43/1-43/56-70 |
| HCFO-1122a/n-butane/HFC-134 | 1-26/1-26/73-91 |
| HCFO-1122a/n-butane/HFC-227ea | 1-75/1-76/24-32 |
| HCFO-1122a/isobutane/HFC-125 | 1-76/1-76/23-29 |
| HCFO-1122a/isobutane/HFC-134a | 1-43/1-43/56-70 |
| HCFO-1122a/isobutane/HFC-134 | 1-26/1-26/73-91 |
| HCFO-1122a/isobutane/HFC-227ea | 1-75/1-76/24-32 |
| HCFO-1122a/DME/HFC-125 | 1-76/1-76/23-29 |
| HCFO-1122a/DME/HFC-134a | 1-43/1-43/56-70 |
| HCFO-1122a/DME/HFC-134 | 1-26/1-26/73-91 |
| HCFO-1122a/DME/HFC-227ea | 1-75/1-76/24-32 |
| HCFO-1122a/NH₃/HFC-125 | 1-76/1-76/23-29 |
| HCFO-1122a/NH₃/HFC-134a | 1-43/1-43/56-70 |
| HCFO-1122a/NH₃/HFC-134 | 1-26/1-26/73-91 |
| HCFO-1122a/NH₃/HFC-227ea | 1-75/1-76/24-32 |

### EXAMPLE 1

### Flammability

Burning velocity (By) is a criterion to differentiate a refrigerant flammability class 2 (Flammable) and class 2L (Lower Flammability) per ANSI/ASHRAE 34-2019. The maximum burning velocity of the refrigerant must be less than 10 cm/s to be classified as 2L. BV is measured at ambient temperature in a closed cylindrical vessel with transparent windows. Ignition is accomplished with tungsten electrodes (attached to a 15 kV, 30 mA power supply) spaced ¼′ apart in the center of the vessel. The image is recorded with proper photography techniques using a constant pressure method, where the xenon lamp light source and series of mirrors were used. The burning velocity of R-32, R-152a and HFO-1122a were measured in accordance with ANSI/ASHRAE 34-2019. The results are summarized in Table 8.

TABLE 8

| | | ASHRAE flammability |
|---|---|---|
| Refrigerant | Maximum BV | classification |
| R-32 | 6.6 | 2L |
| R-152a | 22.9 | 2 |
| HFO-1122a | 7.5 | 2L |

1. A heat transfer composition comprising 1-chloro-1,2 difluoroethylene (HFO-1122a).

2. A heat transfer system selected from the group consisting of a refrigeration system, an air-conditioning, a heating and a chilling containing the heat transfer composition of claim 1.

3. The heat transfer composition of claim 1 further comprising a hydrofluorocarbon, hydrochlorofluorocarbon, hydrofluoroolefin, fluorinated cyclopropane, fluorinated methyl cylcopropane, hydrofluorochlorocarbon, hydrocarbon, hydrofluoroether, fluoroketone, chlorofluorocarbon, hydrochlorofluoroolefin, carbon dioxide, ammonia, dimethyl ether, and mixtures thereof.

4. The heat transfer composition of claim 3 where the hydrofluorocarbon is selected from the group consisting of difluoromethane (HFC-32); 1-fluoroethane (HFC-161); 1,1-difluoroethane (HFC-152a); 1,2-difluoroethane (HFC-152); 1,1,1-trifluoroethane (HFC-143a); 1,1,2-trifluoroethane (HFC-143); 1,1,2,2-tetrafluoroethane (HFC-134); 1,1,1,2-tetrafluoroethane (HFC-134a); 1,1,1,3,3-pentafluoropropane (HFC-245fa); 1,1,2,2,3-pentafluoropropane (HFC-245ca); 1,1,1,2,3-pentafluoropropane (HFC-245eb); 1,1,1,3,3,3-hexafluoropropane (HFC-236fa); 1,1,1,2,3,3,3-heptafluoropropane (HFC-227ea); 1,1,1,3,3-pentafluorobutane (HFC-365mfc), 1,1,1,2,3,4,4,5,5,5-decafluoropropane (HFC-4310), and mixtures thereof.

5. The heat transfer composition of claim 3 where the hydrofluorocarbon is 1,1,1,2-tetrafluoroethane (HFC-134a).

6. The heat transfer system of claim 3 where the hydrofluoroolefin is selected from the group consisting of 1,1,2-trifluoroethene (HFO-1123), 1,1-difluoroethylene (HFO-1132a), E-1,2-difluoroethylene (HFO-1132(E)), 3,3,3-trifluoropropene (HFO-1234zf); 2,3,3,3-tetrafluoropropene (HFO-1234yf); E-1,3,3,3-tetrafluoropropene (E-HFO-1234ze); 1,2,3,3,3-pentafluoropropene (HFO-1255ye); Z-1-chloro-2,3,3,3-tetrafluoropropene (HCFO-1224yd(Z)), E-1,1,1,3,3,3-hexafluorobut-2-ene (E-HFO-1336mzz); Z-1,1,1,3,3,3-hexafluorobut-2-ene (Z-HFO-1336mzz); 1,1,1,4,4,5,5,5-octafluoropent-2-ene (HFO-1438mzz) and mixtures thereof.

7. The heat transfer composition of claim 3 where the hydrofluoroolefin is 2,3,3,3-tetrafluoropropene (HFO-1234yf).

8. The heat transfer composition of claim 1 further comprising a refrigerant selected from 2,3,3,3-tetrafluoropropene (HFO-1234yf); 1,1,1,2-tetrafluoroethane (HFC-134a), and mixtures thereof.

9. The heat transfer composition of claim 8 comprising from 1% to 50% by weight of a refrigerant selected from 2,3,3,3-tetrafluoropropene (HFO-1234yf); 1,1,1,2-tetrafluoroethane (HFC-134a), and mixtures thereof.

10. The heat transfer composition of claim 8 comprising 2,3,3,3-tetrafluoropropene (HFO-1234yf) and 1,1,1,2-tetrafluoroethane (HFC-134a) with from 25% to 75% by weight of 2,3,3,3-tetrafluoropropene (HFO-1234yf) based on the total quantity of 2,3,3,3-tetrafluoropropene (HFO-1234yf) and 1,1,1,2-tetrafluoroethane (HFC-134a).

11. The heat transfer composition of claim 1 further comprising a lubricant.

12. The heat transfer composition of claim 11 where the lubricant is selected from polyol ester oils, polyglycols, polyalkylene glycols, polyvinyl ethers, mineral oils, alkyl benzene oils, polyalpha olefins, and mixtures thereof.

13. The heat transfer composition of claim 11 where the lubricant is selected from polyol ester oils, mineral oils, alkyl benzene oils, and mixtures thereof.

14. A sprayable composition comprising the heat transfer composition of claim 1.

15. A blowing agent composition comprising the heat transfer composition of claim 1.

16. A polymer foam made using the blowing agent of claim 15.

17. A propellant composition comprising the heat transfer composition of claim 1.

18. An aerosol composition comprising the heat transfer composition of claim 1.
